(19) United States
(12) Patent Application Publication
(10) Pub. No.: US 2024/0150153 A1
(43) Pub. Date: May 9, 2024

(54) METHOD FOR OPERATING AN ELEVATOR SYSTEM AND ELEVATOR SYSTEM

(71) Applicant: Inventio AG, Hergiswil (CH)

(72) Inventors: Martin Kusserow, Luzern (CH); Christian Studer, Kriens (CH); Qixuan Zhang, Thalwil (CH)

(21) Appl. No.: 18/551,886

(22) PCT Filed: Mar. 7, 2022
(86) PCT No.: PCT/EP2022/055741

§ 371 Date: Sep. 22, 2023

(30) Foreign Application Priority Data
Mar. 30, 2021 (EP) 21166079.0

(51) Int. Cl. B66B 1/46; B66B 1/34

(52) U.S. Cl. CPC B66B 1/468; B66B 1/3461; B66B 2201/4653

(57) ABSTRACT

An elevator system includes a beacon adapted for broadcasting, when activated, a beacon signal to a mobile device carried by a user, a sensor device, and a controller adapted for selectively activating the beacon. A method for operating the elevator system includes capturing a capture of a user by the sensor device, the capture including capture data indicative of a user activity. The method further includes inferring, from the capture data, an intention data indicative of the user's intention to perform an elevator boarding, and, under the condition that the intention data indicates an intention of the user to perform an elevator boarding, activating the beacon to broadcast a beacon signal, and receiving, by the controller, an instruction signal sent by a mobile device upon having received the beacon signal.

### FIELD

Aspects of the disclosure relate to a method for operating an elevator system and an elevator system, particularly an elevator system for transporting passengers. Further aspects relate to an improved call function, particularly a call function utilizing a user capture to infer an intention of the user to board the elevator. Further aspects relate to an improved interaction between a beacon, a mobile device and an elevator controller for calling an elevator.

### BACKGROUND

Passenger elevators are widely known as useful infrastructure components for the transport of passengers within installations, such as between the floors of a building. In conventional elevator installations, passengers interact with a terminal arranged in the vicinity of the elevator landing to call an elevator car to the landing, e.g. by pressing a call button. The elevator controller then, together with user inputs commonly provided within the elevator car after the user has boarded the elevator car, utilizes such call signals to plan a route for one or more elevator cars to satisfy all pending call requests, and operates the elevator installation accordingly.

Because the elevator call is made at a late point in time, usually when the user already is close to the elevator landing, unnecessarily long waiting times can occur. Since many users plan to use the elevator long before the elevator call can be made at the landing terminal, different solutions for the more efficiently calling an elevator to a landing have been proposed in the art. Many of the proposed solutions operate under the assumption that providing the elevator controller with data indicating potential future elevator boardings at an early point in time can reduce the average user wait time and result in a more efficient elevator operation.

U.S. Pat. No. 6,209,685 B1 discloses an arrangement of transponders provided in the vicinity of the elevator installation and responders located on the potential users. When a transponder interacts with a responder in its vicinity, it is decided, based on a predefined ruleset or a recorded user history, if the user is likely to take the elevator at this time, and the elevator is called to the respective level automatically. While the described system can, compared to the conventional call operation described above, reduce the average user wait time, there is a certain risk that some users will falsely be assigned low-priority calls due to their use history, or that users with no intention to use the elevator installation will create false-positive calls, thereby reducing the overall efficiency and effectiveness of the elevator installation.

In light of the above, it is beneficial to provide an improved method for operating an elevator system, particularly an elevator system with an improved call function.

### SUMMARY

According to an aspect, a method for operating an elevator system is provided. The elevator system includes a beacon adapted for broadcasting, when activated, a beacon signal to a mobile device carried by a user, a sensor device, and a controller adapted for selectively activating the beacon. The method includes capturing a capture of a user by the sensor device, the capture including capture data indicative of a user activity. The method further includes inferring, from the capture data, an intention data indicative of the user's intention to perform an elevator boarding; and, under the condition that the intention data indicates an intention of the user to perform an elevator boarding, activating the beacon to broadcast a beacon signal, and receiving, by the controller, an instruction signal sent by a mobile device upon having received the beacon signal.

According to a further aspect, an elevator system is provided. The elevator system includes a beacon activatable by a beacon controller. The beacon is configured for broadcasting, when activated, a beacon signal receivable by a mobile device, and a sensor device configured for capturing a capture of a user. The capture includes capture data indicative of a user activity. The elevator system further includes the beacon controller and an elevator controller. The beacon controller is connected to the sensor device for receiving the capture data from the sensor device. The beacon controller is configured for inferring, from the capture data, an intention data indicative of the user's intention to perform an elevator boarding. The beacon controller is connected to the beacon for activating the beacon under the condition that the intention data indicates an intention of the user to perform an elevator boarding. The elevator controller is configured for receiving an instruction signal sent by the mobile device upon having received the beacon signal.

Next, general aspects of the invention are described. The aspects are, however, not limited to any particular embodiment. Instead, any aspect described herein can be combined with any other aspect(s) or embodiments described herein unless specified otherwise.

According to an aspect, a beacon is provided. The beacon is configured for sending a beacon signal, particularly broadcasting a beacon signal. The broadcast can be configured for being sent to and/or received by a receiving device, such as the mobile device, however, the presence of a receiving device or the capability of the receiving device to receive the broadcast is typically not required for the broadcasting of the signal. The beacon can be a radio frequency beacon configured for sending a beacon signal. The beacon signal can be a radio frequency signal. According to embodiments, the beacon is configured for sending or broadcasting a radio frequency signal, i.e. the beacon signal. The beacon signal can include a beacon identity. The beacon identity can be any information or data transmittable by the beacon signal. In a beneficial embodiment, the beacon identity includes data for identifying the beacon or attributes of the beacon, such as a beacon location, an identifier of the elevator landing, a location of the elevator landing, or such. The beacon identity can allow a receiving device, such as the mobile device, or a further device that is not the receiving device to identify the beacon according to the received beacon signal. In one example, the beacon identity includes data allowing a receiving device to conclude that the received beacon signal was sent by a specific beacon located at a specific location. In a further example, the beacon identity can include information or data, such as a URL, the URL e.g. allowing the mobile device to access a web-based service. In the example, the URL can link to a web-based service and include a beacon identity, thereby allowing the web-based service to conclude that the beacon signal sent by the beacon having the beacon identity was received by the receiving device.

According to an aspect, the beacon can broadcast the radio frequency signal, i.e. the beacon signal, within a limited range of a landing of the elevator installation. In a beneficial embodiment, the range of the radio signal is limited such that it can only be received when the receiving device, such as the mobile device, is in the vicinity of the landing of the elevator installation. The range of the radio frequency signal can be limited to a range of 10 m-50 m, 20 m-40 m, 10 m-20 m, 5 m-10 m, or such. It is understood that the radio frequency signal can only be received when both the signal strength and the signal to noise ratio of the radio frequency signal are sufficient.

According to an embodiment, to reduce the range of the radio frequency signal, the signal strength, i.e. the transmit power, can be limited to e.g. less than 100 mW, less than 10 mW, less than 5 mW, less than 3 mW, less than 1 mW, less than 0.5 mW, or less than 0.1 mW, e.g. when assuming a non-directional signal source such an omnidirectional antenna. A different signal strength may be chosen for some or each beacon according to the local requirements, e.g. it can be desirable to increase the range of the radio frequency signal if the area to be covered by the radio frequency signal is large, e.g. in a large building lobby. Likewise, it can be desirable to reduce the range of a beacon signal if multiple beacons are provided. By providing a beacon with a limited range and no overlap with other beacons, it can be assured that only receiving devices within a defined location receive the beacon signal. Furthermore, the receiving device or any device the received beacon signal is forwarded to can conclude that, when the beacon signal is received, that the beacon signal was broadcast by a beacon within a range close to the receiving device. Furthermore, it can be assured that the broadcast is only sent to receiving devices intended to receive the broadcast.

According to an aspect, the beacon can utilize a known protocol or standard for sending or broadcasting the beacon signal. In a first example, the protocol can be a Bluetooth protocol, such as a Bluetooth Low Energy (BLE) protocol. In the example, the beacon can be a Bluetooth Low Energy beacon. In another example, the protocol can be an Ultra-Wideband (UWB) protocol, and the beacon can be an Ultra-Wideband beacon. Further technologies or protocols for providing a localized beacon broadcast signal can be equally suitable.

According to an aspect, the beacon is an activatable beacon, i.e. the beacon can be set to broadcast a beacon signal, i.e. a radio frequency signal, when activated, and set to not broadcast a beacon signal when the beacon is deactivated. The beacon can be activated by a controller or sub-controller, such as the beacon controller. The beacon can be connected to the controller. The beacon can receive an activation signal by the controller. According to an embodiment, the beacon can be configured for dynamically adjusting the range of the radio frequency signal, e.g. according to a control signal provided by the controller. Dynamically adjusting the range can include dynamically adjusting the range according to an intention data, which will be described in further detail below, particularly to allow the receiving of the beacon signal by a receiving device that is e.g. provided far away, has an insensitive receiver, is susceptible to signal interference, or such. By providing an activatable beacon, it can be assured that the broadcast is only sent to receiving devices intended to receive the broadcast, particularly by only sending a broadcast when it is intended for a receiving device to receive the broadcast.

According to an aspect, a sensor device is provided. The sensor device is configured for capturing a capture of a user. The capture comprises data, i.e. capture data, indicative of a user activity. The sensor device can be connected to a controller or sub-controller, such as the sensor device controller or the beacon controller, for providing the capture, particularly for providing the capture data, to a controller or a sub-controller, such as the sensor device controller or the beacon controller. The capture of the user can be a capture of the user in a location relevant for deciding, based on the user activity, if the user intends to board the elevator, particularly if the user intends to perform an elevator boarding at the elevator landing captured by or corresponding to the sensor device. Accordingly, in an embodiment, the sensor device can be provided in the vicinity of a landing of the elevator system, particularly a landing having a beacon installed in the vicinity of the landing, particularly a beacon to be activated in response to the user activity captured by the sensor device, or the intention data derived thereof. In an example, the sensor device can be provided in the vicinity of an elevator landing, e.g. in the lobby of a building, and capture users in the vicinity of the elevator landing. In another embodiment, the sensor device can be provided away from the landing of the elevator system and be configured to capture a further location or an area relevant for deciding, based on the user activity within the area, if a user intends to perform an elevator boarding. In an example, an elevator landing can be located on one end of a long hallway, and a sensor device can be located on the other end of the long hallway. In the example, a capture of a user entering the hallway can indicate that the user intends to board the elevator, even though the positions of the sensor device and the elevator landing are distant.

According to an aspect, the sensor device can include a visual camera. The visual camera can be a dedicated visual camera for capturing a capture of the user. The camera can be provided, e.g. at a specific location, for enabling a capture of a relevant area for inferring, from the capture data, an intention data indicative of a user's intention to perform an elevator boarding. The visual camera can be specifically provided for operating according to the system or method provided herein, e.g. the visual camera can be installed together with the components of the elevator system described herein. The visual camera can further be a camera included in a camera system or network, particularly a preexisting system or network, such as a building camera system, such as a CCTV system or a security system. The camera can be a door camera, a wall-mounted camera, a ceiling-mounted camera, a security camera or such. The camera system can be preexisting, and the provided method or system, particularly the controller, such as the beacon controller, can be configured for enabling a connection to the preexisting camera system. The visual camera can provide capture data as a video signal or video stream, e.g. to the beacon controller, or any other controller. The visual camera is typically not limited to any particular video format, however, in a beneficial embodiment, the visual camera provides an analog video signal, such as PAL or NTSC, or a digital video stream with a resolution of at least 320×240 pixels, a grayscale image with a color depth of at least 4 bits and a framerate of at least 2 frames per second.

According to an aspect, the sensor device can include an event camera and/or a thermal imaging camera. The event camera and/or the thermal imaging camera can be provided according to some or all aspects of the visual camera described above. Particularly, preexisting systems, e.g. systems already present in a building, can be included. Event cameras, such as neuromorphic cameras, silicon retinas or dynamic vision sensor, can improve or facilitate the detection of movement and provide an improved dynamic range. Event cameras can be provided if an added emphasis on the user's movement is desired when inferring the intention data. Thermal imaging cameras can improve the differentiation between users and cold objects. The event camera and/or the thermal imaging camera can be provided when an improved capture under low-light conditions is desired.

According to an aspect, the sensor device can include a radar sensor and/or a lidar sensor and/or a sensor based on ultrasonic sound, such as a motion detector. The sensors can be provided according to some or all aspects of the visual camera described above. Particularly, preexisting systems, e.g. systems already present in a building, can be included. The sensors can detect the presence of a user within a defined area. Furthermore, the sensors can be configured for detecting doppler effects caused by the motion of the user, and provide capture data from which a position, movement direction and movement speed of the user can be inferred in a beneficial manner.

According to an aspect, the sensor device can include an occupancy sensor, particularly an occupancy sensor provided within the building installation. The occupancy sensor can be provided according to some or all aspects of the visual camera described above.

According to an aspect, the sensor device can include multiple sensor devices, particularly combinations of multiple sensor devices. The sensor devices can be of the same type, e.g. several visual cameras. The sensor devices can be combinations of the sensor devices as described herein, e.g. a visual camera can be combined with a radar sensor and/or an occupancy sensor. The sensor devices can be provided to allow the capture of several different areas, or the capture of an area from multiple angles. A combination of different types of sensor devices can improve the quality of the capture data and/or provide redundancy, particularly if the conditions of the captured environment vary. In one example, the capture data of a visual camera might be insufficient in low-light conditions such as during the nighttime, and the capture data can be improved by further providing a radar sensor, an occupancy sensor, any of the sensors described above, or such.

According to an aspect, a controller is provided. In one example, the controller can include sub-controllers, such as an elevator controller for controlling the elevator, particularly for planning and/or executing the movement or transport pattern of one or more elevator cars, and a beacon controller for activating or deactivating the beacon. The controller or a sub-controller, such as the beacon sub-controller, can include a sensor device controller for controlling or operating the sensor device. The sensor device controller can be connected to the sensor device for receiving data, particularly sensor data, from the sensor device. The sensor device controller can, if desirable, perform calculations, operations, preliminary analysis, filtering or such on the sensor data and provide the modified sensor data, which can be capture data indicative of a user activity, e.g. to the beacon controller. In one example, the functionality of the sensor device controller can be included in the beacon controller. The controller and the sub-controllers can be multiple hardware devices at different locations within or in the vicinity of the elevator system. The controller can further combine some or all hardware devices in one assembly, or be implemented in one or more hardware devices, for example in the form of combined hardware modules, or in the form of software modules, such as programs, executed on one or more hardware modules comprising a CPU, transient and/or permanent memory, a program store, and/or input and output signal ports. Furthermore, the controller or one or more sub-controllers or parts thereof can be provided at a remote location, particularly if certain aspects or functions of the controller are implemented as decentralized services, such as on a remote device, such as a server or a cloud computer.

According to an aspect, the method and/or the elevator system are configured to interact with a mobile device as described herein. According to an aspect, the method and/or the elevator system can include the mobile device. The mobile device can be a receiving device such as described above. The mobile device can be a mobile device carried by the user, such as a transmitter/receiver, a smartphone, a smartwatch, a smart device such as smart glasses, a smart implant, a dedicated key fob, a tablet, a phablet or such. The mobile device can be a wearable device. The mobile device can be configured for receiving a beacon signal broadcast by the beacon. The mobile device can further be configured for sending an instruction signal. The instruction signal can be sent such that it is transmitted to and received by the elevator controller. The mobile device can include a receiver for receiving the beacon signal. The mobile device can include a transmitter for transmitting the instruction signal. The mobile device can include a software and be configured for executing the software. According to an embodiment, the receiver for receiving the beacon signal is a passive receiver, i.e. no response from the mobile device to the beacon is required. According to an embodiment, the transmitter can be a transceiver, e.g. a modem providing a data connection to a network such as a local data network, or a wide area network such as the internet, such as a WiFi modem, a GSM module, an LTE module, a 4G module or a 5G module. Sending an instruction signal can include directly transmitting the instruction signal to the controller, e.g. by contacting the controller. Sending an instruction signal can include requesting data from a device connected to the data network. The request can include the instruction signal. The device connected to the data network can be a controller, such as the elevator controller described herein, or a device connected to the controller or elevator controller configured for forwarding the instruction signal to the controller.

According to an aspect, the mobile device can be configured for receiving a beacon signal and sending an instruction signal upon having received the beacon signal. According to an aspect, the method described herein can include receiving a beacon signal by the mobile device and activating, by the received beacon signal, the sending of an instruction signal to the controller by the mobile device. The instruction signal can instruct the elevator controller to perform actions, such as registering a call to send an elevator car to the level on which the user is currently located for allowing the user to board the elevator. Upon receiving the beacon signal, the mobile device can be triggered to perform an operation.
The operation can include sending the instruction signal, particularly as a direct result of having received the beacon signal.
The operation can further include prompting the user to send an instruction signal, e.g. by executing a software or program on the mobile device which displays a prompt, and as a result of the prompt receives an input from the user. Depending on the user input, the instruction signal can be sent or not sent.
The operation can further include informing the user that an instruction signal will be sent unless cancelled by the user. For this, a prompt as described above can be implemented, further including e.g. a timer that allows the user to cancel the sending of the instruction signal until the timer expires. Depending on the user input, the instruction signal can be sent or not sent.
The operation can further include informing the user that no instruction signal will be sent unless explicitly requested by the user. For this, a prompt as described above can be implemented, further including e.g. a timer that allows the user to instruct the sending of the instruction signal until the timer expires. Depending on the user input, the instruction signal can be sent or not sent.
The operation can further include sending the instruction signal and informing the user that an instruction signal has been sent. For this, a notification similar to the prompt as described above can be implemented, whereby the notification does not require any further user input.

According to an aspect, the mobile device can be configured to receive the broadcast signal and to send the instruction signal by providing the transmitter and the receiver as described above. The mobile device can further include a software, such as a program or an application (“App”) which enables the mobile device and the required hardware components provided by the mobile device to perform the functions as described herein. In one example, the mobile device can include a Bluetooth module configured for receiving a Bluetooth Low Energy broadcast signal, i.e. the beacon signal. In the example, the mobile device can further include a modem, such as an LTE module, to connect to the elevator controller or a server via the internet, the server being configured for receiving the instruction signal sent from the mobile device via the internet. In the example, the mobile device can include a software that enable the Bluetooth module to listen for and receive a beacon signal and, when a beacon signal is received, perform one or more of the operations as described above. The software can then (in some embodiments depending on a user input) enable the LTE module to send the request, e.g. by sending the instruction signal to the controller or a server. According to an embodiment, the software can include all the described functions, particularly a user interface (UI) implementing prompt functions or notification functions as described above. According to an embodiment, the software can further be configured for displaying a web page, e.g. provided by the controller or a server, and aspects of the application as described above can be implemented within the web page. The web page can include the user interface described above. The URL to access the web page can be included in the beacon identity sent by the beacon signal. The request to access the web page, e.g. the URL, can include the instruction signal, or, together with further user inputs, form the instruction signal.

According to an aspect, the capture of a user captured by the sensor device provides capture data indicative of a user activity. A user activity indicated by the capture data can include, but is not limited to, a movement speed of the user. According to an example, if a user moves quickly and/or constantly, it can, in some cases, be assumed that the user is more likely to intend to arrive at a certain destination. This can be indicative of the user's intention to board the elevator.
A user activity indicated by the capture data can include, but is not limited to, a movement direction of the user. According to an example, if a user moves directly towards the elevator landing, it can, in some cases, be assumed that the user is more likely to intend to board the elevator.
A user activity indicated by the capture data can include, but is not limited to, a position of the user. According to an example, if a user is positioned closely to an elevator landing, it can, in some cases, be assumed that the user is more likely to intend to board the elevator.
A user activity indicated by the capture data can include, but is not limited to, a head direction and/or a gaze direction of the user. According to an example, if a user's gaze is directed to components of the elevator system provided on or in the vicinity of the elevator landing, such as an elevator level display, it can, in some cases, be assumed that the user is more likely to intend to board the elevator.
A user activity indicated by the capture data can include, but is not limited to, a dwell time of the user. According to an example, if a user is positioned closely to an elevator landing or in a lobby adjacent to the elevator landing for a certain amount of time, it can, in some cases, be assumed that the user is waiting for an elevator car to arrive at the landing and is more likely to intend to board the elevator.
A user activity indicated by the capture data can include, but is not limited to, a movement pattern of the user. According to an example, if a user shows a movement pattern, such as a non-directional movement pattern or a stop-and-go behavior, it can, in some cases, be assumed that the user is less likely to intend to board the elevator.
The capture data can be indicative of one or more of the described user activities, or any combinations thereof. Further user activities can be indicated by the capture data.

According to an aspect, an intention data is inferred from the capture data. The intention data can be derived from the user capture including capture data indicative of a user activity, e.g. as described above. The intention data is indicative of an intention of the user to perform an elevator boarding. In one example, the intention data can satisfy an intentionality criterion. The intentionality criterion can, for example, be defined as a confidence or probability parameter exceeding a predetermined threshold. In one example, the user capture can be interpreted or evaluated and result in an intentionality score. The intentionality score can correspond to, e.g. increase, according to the inferred or derived certainty or (assumed) probability of the interpreted or evaluated user capture of the user to result in an elevator boarding. In one example, for a user capture of a user activity or user behavior that corresponds to a high-probability elevator boarding, such as a user waiting in the vicinity of the elevator landing, the intentionality score can be high. If the intentionality score exceeds a threshold, such as a predetermined or predefined threshold, the intentionality criterion is satisfied for this user capture and the intention data derived thereof. In another example, for a user capture of a user activity or user behavior that corresponds to a low-probability elevator boarding, such as a user moving away from the elevator landing, particularly after having left the elevator car, the intentionality score can be low, and the intentionality criterion may not be satisfied. The intentionality score and/or the threshold can be a numeric value, a binary value, a rank within a classification system or such.

According to an aspect, inferring the intention data can include analytic methods suitable for analyzing the capture data. If the capture data includes a video signal, e.g. if the sensor device is an optical sensor device as described above, the analytic method can include an image or shape recognition tool. Known analysis methods, such as algorithms for image processing and image pattern recognition can be utilized. The analysis method can be suitable for recognizing human silhouettes, faces, gaze directions or such. The analysis method can be based on neural networks, such as a convolutional neural network (CNN), such as a multi task cascaded network (MTCNN). According to embodiments, the analysis method can include a combination of multiple image analysis methods, such as one or more of image filtering, image segmentation, a combination of neural networks such as a combination of two, three, four or five neural networks for the recognition of humans or human shaped objects, recognition of faces, recognition of gaze direction, recognition of eye direction, or the like. According to embodiments, the recognition can be performed on single images or frames provided in the video signal, and a position and a direction of the user can be derived from the single image. One or more of the analysis methods described herein may be selected according to the local specifics of the installation the elevator system or method described herein is provided.

According to an aspect, the analysis method can include analyzing several image frames, such as a sequence of frames, e.g. a video signal. The analysis method can include, from the sequence of frames, recognizing a chronology of events or a causality chain, e.g. of the user or the captured data comprising the user activity. According to embodiments, from the user positions and user directions of multiple frames in the video signal, particularly the differences between the frames, a movement direction and a movement speed, e.g. a vector attributed to a user, can be derived. From multiple vectors, a movement pattern of the user can be derived. If the capture data includes data provided by radar or lidar sensors, vectors attributed to a user and distance values of the user to the sensor device can be directly derived from the signal. A user position may be determined by triangulating distance values obtained from several radar or lidar sensors. If the capture data includes data provided by occupancy sensors, a movement pattern of a user may be derived by analyzing the data provided by a network of occupancy sensors, e.g. by providing the controller with a map of the installation (e.g. building) including the location occupancy sensors provided therein, so that from multiple sensor data provided by multiple occupancy sensors, user positions and movement patterns can be concluded. From the capture data and the values derived thereof, the intention data can be inferred according to aspects and examples described herein, e.g. a user position can result in a user position score and, over time, in a dwell time score; a vector can result in a user speed score, a user movement direction score; a user head direction can result in a head direction and/or gaze score. Further methods for analyzing the capture data and inferring an intention data are possible.

According to an aspect, inferring the intention data, e.g. as described above, can yield a boarding probability indicator of the captured user. The boarding probability indicator can be indicative of the captured user's intention to perform an elevator boarding. The intention of the user to perform an elevator boarding can be inferred by evaluating if the capture data is indicative of a user activity having a boarding probability indicator for boarding the elevator exceeding a predefined threshold. The boarding probability indicator can be a component of an intentionality criterion, particularly a probability parameter, as described above. The boarding probability indicator can be a score, particularly a score set between known limits, such as 0 to 1, or 0% to 100%, or −100% to +100%. Providing a boarding probability indicator can facilitate determining, by comparing the boarding probability indicator to a threshold, such as a minimum probability threshold, if an intentionality criterion is satisfied, i.e. if the intention data indicates an intention of the user to perform an elevator boarding or not. The boarding probability indicator does not necessarily have to correspond to the statistical probability of a certain user activity to result in an elevator boarding, e.g. if a user activity statistically results in a 10% chance for the user to perform an elevator boarding, the boarding probability indicator can indicate a boarding probability below 10%, and/or if a user activity statistically results in a 90% chance for the user to perform an elevator boarding, the boarding probability indicator can indicate a probability above 90%.

According to an aspect, inferring the intention data can include classifying the capture data according to user activities, particularly user activities identifiable from the capture data. The classification scheme, together with the classification of the user's activity, can be an intention data. The classification can include assuming that one or more classes indicate an intention of the user to perform an elevator boarding, and assuming that one or more classes do not indicate the intention. Possible classes can include: The user is approaching, particularly approaching the elevator landing; the user is waiting, particularly waiting in the vicinity of the elevator landing; the user is passing by, particularly passing by the elevator landing; or the user is located in a proximity of a landing, particularly located in a position known to have a high boarding probability. Classifying the capture data can include inferring a probability indicator for each class. Classifying the capture data can result in a user activity being classified in multiple classes. Inferring, from the classified capture data, if the user intends to perform an elevator boarding can include determining if the inferred probability indicator of one or more classes exceeds a predefined threshold. According to an embodiment, one class can exclude the evaluation of another class, e.g. one class can be scored higher when inferring the intention data, particularly if one user activity class excludes another user activity class. In one example, if it is inferred with a high confidence that a user is passing by, it can be beneficial to ignore the user position class.

According to an aspect, the method described herein can include dynamically modifying the intention data, particularly the boarding probability indicator. According to an aspect, the beacon controller can be configured for dynamically modifying the intention data, particularly the boarding probability indicator. Dynamically modifying the intention data can include dynamically modifying the inferring of the intention data, particularly any scoring algorithms included in inferring the intention data, and/or parameters used for inferring the intention data, such as parameters used by a scoring algorithm. Dynamically modifying the intention data can be based on a number of capture data and corresponding elevator boardings resulting from the user activity indicated by the capture data. The dynamically modifying the intention data can include a learning algorithm. The learning algorithm can record a number of capture data and elevator boardings, the capture data and the elevator boarding being correlated. The learning algorithm can further record a number of intention data, particularly boarding probability indicators, corresponding to the capture data and the elevator boardings. Elevator boardings, in the context of the learning algorithm, can also include false-positive and false-negative elevator boardings, i.e. capture data that was analyzed and falsely resulted in an intention data indicating an elevator boarding or an elevator non-boarding. If provided, an instruction signal including a user input can be considered a boarding or a non-boarding, e.g. if a user cancels the elevator boarding because the intention data wrongly indicated an intention to board, which was then corrected by a user input, this can be considered a false-positive elevator boarding. The learning algorithm can, after a number of capture data and correlated elevator boardings have been recorded, perform a statistical analysis and derive, from the analysis, if the number of false-positive or false-negative elevator boardings corresponding to a user activity or class of user activities exceeds a predefined threshold. If the threshold is exceeded, the learning algorithm can modify the inferring of the intention data to adjust the inferring of the intention data to better represent the observed boarding probability correlated with the recorded user activity, e.g. by modifying parameters used during the scoring of the capture data for the particular user activity.

According to an aspect, to implement the dynamically modifying of the intention data, a plurality of user activity/boarding probability indicator correlations can be stored in the controller, such as the beacon controller. At least one of the plurality of activity/boarding probability indicator correlations can represent the boarding probability indicator for a known user activity indicated by the capture data of a plurality of known user activities indicated by the capture data.

Dynamically modifying the intention data can result in a better prediction of the user boarding probability, thereby reducing the number of false-positive and false-negative predictions. A high prediction accuracy can improve the efficiency and effectiveness of the elevator installation and reduce both the individual and the average user wait time. Since the elevator system and the method described herein can be installed in a wide variety of installations with different architectures, a standard factory setting might not be suitable in some cases, particularly if installed in buildings with unusual structural features, non-optimal pre-existing sensor devices or unusual user behavior. Dynamically modifying the intention data as described herein can further reduce the required setup, adjustment and maintenance time, since it is not necessary to manually adapt or calibrate the system to the installation.

According to an aspect, under the condition that the intention data indicates an intention of the user to perform an elevator boarding, the beacon is activated to broadcast the beacon signal. The intention data can indicate the intention of the user to perform an elevator boarding if it fulfills or satisfies an intentionality criterion as described above. The beacon can send a beacon signal as described above. When the beacon is activated to send the beacon signal, a mobile device in range, i.e. in the vicinity of the beacon and/or close enough to the beacon to receive the beacon signal, can receive the beacon signal. The mobile device can be configured for sending, upon having received the beacon signal, to send an instruction signal, as described above. The instruction signal can be sent to a controller, such as the elevator controller, and instruct the controller to perform an operation, such as described above, e.g. result in the controller to register a call to the level on which the beacon and/or the sensor device is installed. Activating the beacon can include deactivating the beacon after the broadcast has been sent, particularly after the broadcast has been received by the receiving device. An indicator for the receiving device having received the broadcast can be receiving an instruction signal, e.g. sent by the mobile device, by the controller. Furthermore, the beacon may be activated only for a limited time, such as for less than 5 s, less than 2 s or less than 1 s.

According to an aspect, the elevator system and method for operating the elevator system can include, under the condition that the intention data indicates an intention of the user to perform an elevator boarding, calling the elevator to a landing of the elevator system. In this embodiment, the elevator system does not require receiving an instruction signal before calling the elevator. A beacon signal is still provided, and the user can have the option to cancel the call by interacting with the mobile device as described above. This can further reduce the user wait time, particularly in low passenger load conditions, where it can be beneficial to operate the elevator system even before having received an instruction signal by the controller.

According to an aspect, the elevator system can include a plurality of beacons. The plurality of beacons may be beacons provided in different areas on the same level and/or corresponding to the same elevator landing, or be provided on different levels of the elevator installation. The beacons may be provided such that a number of relevant areas, such as several or all positions within the installation for which a user capture is captured, can receive a beacon signal provided by a beacon in the vicinity of the relevant area. According to the aspect, a selection of the plurality of beacons is activated, particularly after the intention data indicates an intention of a user to perform an elevator boarding, such that the activated beacons are in the vicinity of the user for which the user's intention data indicates an intention to perform an elevator boarding. Other beacons of the plurality of beacons not in the vicinity of the user can remain inactive, i.e. not be activated. By only selectively activating beacons in the vicinity of the user, the receiving of a beacon signal by a receiving device located on a user that has no intention to use the elevator is avoided, which can reduce unnecessary user interaction with e.g. the mobile device, and/or false-positive sending of an instruction signal.

By operating an elevator system as described above, a high correlation between a user activity and the subsequent calling of an elevator car to the landing can be achieved. The calling of the elevator car can happen automatically, without the user having to operate a terminal at the elevator landing before the controller receives the call. In a beneficial embodiment, a user can enter a building and is recognized, by the elevator system, to have the intention to board the elevator. The elevator system then calls the elevator to a landing, thereby allowing the user to seamlessly approach the landing and directly enter the elevator car already waiting for the user.

### DESCRIPTION OF THE DRAWINGS

Details of the disclosure will be described in the following with reference to the figures, wherein:

FIG. 1 is a schematic view of an elevator landing including the elevator system as described herein; and

FIG. 2 is a flowchart representing a method for operating an elevator system as described herein.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment applies to a corresponding part or aspect in another embodiment as well.

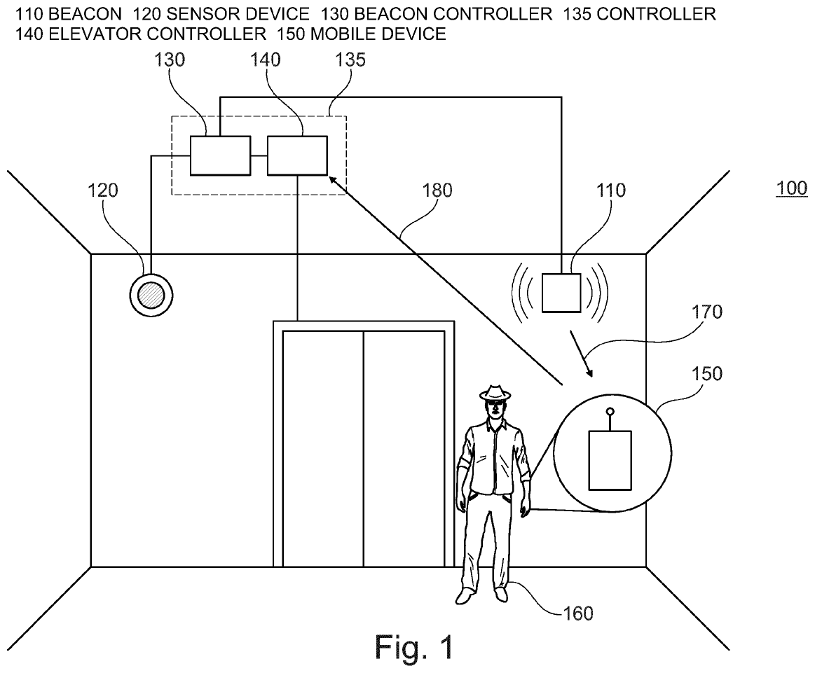

Referring to FIG. 1, an elevator system 100 in a configuration according to an embodiment is now described in an exemplary scenario. In the embodiment, an elevator landing is located at the end of a hallway of a floor within a building. The elevator system includes a beacon 110, a sensor device 120, a beacon controller 130 and an elevator controller 140. In the embodiment, the beacon controller 130 and the elevator controller 140 are combined into a single controller 135. A user 160, having just arrived, can be seen standing in front of the elevator landing. The user carries, in his pocket, a mobile device 150, such as a smartphone. The mobile device 150 is a mobile device according to an aspect or embodiment described herein and has a software installed thereon, the software enabling the mobile device 150 to receive the beacon signal 170 and send the instruction signal 180. The sensor device 120 is connected to the beacon controller 130 for providing capture data to the beacon controller. The beacon controller 130 is connected to the elevator controller 140, e.g. for receiving instruction signals to provide to the learning algorithm, and/or for directly calling the elevator to the landing, however, according to embodiments, this connection can be optional. The beacon controller 130 is further connected to the beacon 110 for enabling or disabling the beacon 110. The elevator controller 140 is connected to the elevator system for operating the elevator system.

As shown in FIG. 1, according to an embodiment, the sensor device 120 is a visual camera provided on a wall in the vicinity of the elevator landing and captures the area around the elevator landing. The capture includes visual data of the user 160, particularly the user's activity. The capture data comprises a video signal. The sensor device 120 provides the capture data including the captured user activity to the beacon controller 130. In the example shown in FIG. 1, according to the embodiment, the user 160 is standing in front of the elevator landing. The beacon controller 130 infers from the capture data an intention data.

According to an embodiment, the beacon controller 130 utilizes an image recognition algorithm for recognizing human silhouettes within the capture data, and concludes for the example shown in FIG. 1 that an intentionality criterion defined as a user activity corresponding to a class of user activities showing a user waiting in front of the elevator landing is satisfied. The decision can be made by comparing a score provided by the image recognition algorithm to a predefined threshold. The threshold can be dynamic, i.e. if the elevator system operates under low passenger load, the threshold can be lowered to allow even users with a low boarding probability to quickly enter the elevator, if so desired.

As shown in FIG. 1, according to an embodiment, the beacon controller 130 then activates the beacon 110 to broadcast a beacon signal 170. The beacon signal includes a beacon identity, provided in the form of a character string representing a URL. The beacon signal is a −12 dBm or 0.063 mW BLE broadcast with a range of less than 20 m. The beacon signal 170 is received by the mobile device 150 carried by the user. Due to the limited range, the beacon signal is only received by mobile devices in the vicinity of the beacon and, as shown in FIG. 1, only by the intended user 160. The mobile device 150, upon having received the beacon signal 170, sends an instruction signal 180 to the elevator controller 140. In the example, the mobile device 150 is connected to a WiFi network provided within the building and is thereby connected to the internet. The mobile device 150 sends the instruction signal 180 by accessing a URL included in the beacon signal with a web browser, i.e. by sending a request packet including the provided URL via the internet to an address included in the URL. The website accessed by the URL is hosted on a server, and the server forwards the instruction signal to the elevator controller, which, in the example, is also connected to the internet. After having successfully sent the instruction signal, the mobile device notifies the user that the elevator has been called by playing a short confirmation “ding” and exits the web browser, thereby not requiring any additional user input.

According to an embodiment, the elevator controller 140, having received the instruction signal, registers a call to the floor on which the user 160 is present, and moves the elevator car to the floor. The user can then enter the elevator car and use the elevator.

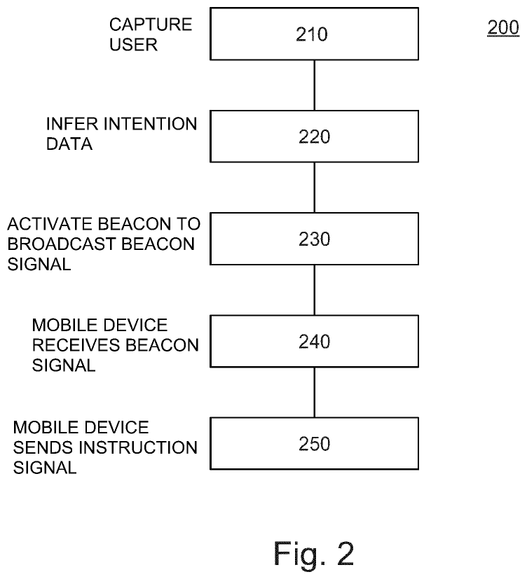

Referring now to FIG. 2, a method for operating an elevator system 200 is provided. The method can be a method according to one or more aspects or embodiments described herein. Systems or components of the systems described herein can be configured for performing a method according to the embodiment or aspects of the embodiment. The method 200 includes providing a beacon, a sensor device and a controller according to aspects and embodiments described herein. The method includes capturing 210 a capture of a user by the sensor device. The capture comprises capture data indicative of a user activity. The method further includes inferring 220, from the capture data, an intention data indicative of the user's intention to perform an elevator boarding. In operation 230, under the condition that the intention data indicates an intention of the user to perform an elevator boarding, the beacon is activated to broadcast a beacon signal. In operation 240, the beacon signal is received by a mobile device. In operation 250, upon receiving the beacon signal, the mobile device activates the sending of an instruction signal to the controller. Operation 250 can further include receiving, by the controller, the instruction signal. The method can further include, after operation 250, operating the elevator system, particularly calling a car of the elevator system to a landing of the elevator system, particularly the landing on which the beacon is located.

According to embodiments, by providing a beacon with a limited signal range and by activating the beacon only after the intention data indicates a high probability boarding, it can be assured that only mobile devices of users with an intention to board the elevator receive the beacon signal and interact with the elevator system, thus reducing unnecessary user interaction or “spam”. Furthermore, also by optionally prompting the user if he intends to board the elevator, the rate of false-positive calls can be reduced. If the rate of false-positive calls is reduced, the passenger load of the elevator system is reduced, thus, the threshold for concluding an intention to board the elevator system can be lowered and, as a result, the rate of false-negative calls and users with long wait times is lowered.

Next, further general aspects of the disclosure are described. The aspects are, however, not limited to any particular embodiment. Instead, any aspect described herein can be combined with any other aspect(s) or embodiments described herein unless specified otherwise.

According to an aspect, the intention of the user 160 to perform an elevator boarding is inferred by evaluating if the capture data is indicative of a known user activity having a boarding probability indicator for boarding the elevator exceeding a predefined threshold.

According to an aspect, a plurality of activity/boarding probability indicator correlations is stored in the controller 130, 135. At least one of the plurality of activity/boarding probability indicator correlations represents the boarding probability indicator for a known user activity indicated by the capture data of a plurality of known user activities indicated by the capture data. The activity/boarding probability indicator correlations can be made available to a learning algorithm, e.g. to enable statistical analysis.

According to an aspect, a method 200 for operating an elevator system further includes, under the condition that the intention data indicates an intention of the user 160 to perform an elevator boarding, calling the elevator to a landing of the elevator system 100.

Further advantages, features, aspects and details that can be combined with embodiments described herein are evident from the dependent claims, the description and the drawings.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for operating an elevator system, the elevator system including a beacon adapted for broadcasting, when activated, a beacon signal to a mobile device carried by a user, a sensor device, and a controller adapted for selectively activating the beacon, the method comprising the steps of:
capturing a capture of the user by the sensor device, the capture including capture data indicative of a user activity of the user;
inferring, from the capture data, an intention data indicative of an intention of the user to perform an elevator boarding;
when the intention data indicates the intention of the user to perform an elevator boarding, activating the beacon to broadcast a beacon signal; and
receiving, by the controller, an instruction signal sent by the mobile device upon having received the beacon signal.

17. The method according to claim 16 including: receiving the beacon signal by the mobile device; and activating, by the received beacon signal, the mobile device to send the instruction signal to the controller.

18. The method according to claim 16 wherein the capture data is indicative of at least one of: a movement speed of the user; a movement direction of the user; a position of the user; a head direction of the user; a gaze direction of the user; a dwell time of the user within a predefined area; and a movement pattern of the user.

19. The method according to claim 16 wherein the inferring the intention data yields a boarding probability indicator of the user, wherein the boarding probability indicator is indicative of the user's intention to perform an elevator boarding.

20. The method according to claim 16 wherein the inferring the intention data includes classifying the capture data according to at least one of: the user is approaching; the user is waiting; the user is passing by, and the user is located in a proximity of a landing of the elevator system.

21. The method according to claim 16 including dynamically modifying the intention data based on a number of the capture data and corresponding elevator boardings resulting from the user activity indicated by the capture data.

22. The method according to claim 16 wherein receiving the beacon signal by the mobile device triggers the mobile device to perform at least one of the following operations: prompting the user to send the instruction signal; informing the user that the instruction signal will be sent unless cancelled by the user; proceeding to send the instruction signal without further user interaction; and informing the user that the instruction signal has been sent.

23. The method according to claim 16 wherein the sensor device includes at least one of a visual camera, an event camera, a lidar sensor, a thermal imaging camera, a radar sensor or a doppler radar sensor, a sensor based on ultrasonic sound, and an occupancy sensor.

24. The method according to claim 16 wherein the beacon is a radio frequency beacon broadcasting the beacon signal as a radio frequency signal within a limited range of a landing of the elevator system and the beacon signal including a beacon identity.

25. The method according to claim 24 including dynamically adjusting the limited range of the radio frequency signal according to the intention data.

26. The method according to claim 16 wherein the beacon is a Bluetooth Low Energy beacon or an Ultra-Wideband beacon.

27. The method according to claim 16 wherein the elevator system includes a plurality of the beacon, and including selectively activating any of the beacons in a vicinity of the user when the intention data is indicative of an intention to perform an elevator boarding.

28. An elevator system comprising:
a beacon activatable by a beacon controller, the beacon adapted to broadcast, when activated, a beacon signal receivable by a mobile device;
a sensor device adapted to capture a capture of a user, the capture including capture data indicative of a user activity of the user;
a beacon controller connected to the sensor device;
an elevator controller;
wherein the beacon controller receives the capture data from the sensor device and infers from the capture data an intention data indicative of an intention of the user to perform an elevator boarding;
wherein the beacon controller is connected to the beacon to activate the beacon when the intention data indicates the intention of the user to perform an elevator boarding; and
wherein the elevator controller receives an instruction signal sent by the mobile device upon the mobile device having received the beacon signal.

29. The elevator system according to claim 28 further comprising the mobile device, wherein the mobile device is adapted to, upon receiving the beacon signal, send the instruction signal to the elevator controller.

30. The elevator system according to claim 28 wherein the sensor device includes at least one of a visual camera, an event camera, a lidar sensor, a thermal imaging camera, a radar sensor or a doppler radar sensor, a sensor based on ultrasonic sound, and an occupancy sensor.

31. The elevator system according to claim 28 wherein the beacon is a radio frequency beacon broadcasting the beacon signal as a radio frequency signal including a beacon identity within a limited range of a landing of the elevator system.

32. The elevator system according to claim 31 wherein the radio frequency beacon dynamically adjusts the limited range of the radio frequency signal according to the intention data.

33. The elevator system according to claim 28 wherein the beacon is a Bluetooth Low Energy beacon or an Ultra-Wideband beacon.

34. The elevator system according to claim 28 wherein the mobile device is a wearable device.

35. The elevator system according to claim 28 including a plurality of beacon, and wherein selected ones of the beacons are activated that are in a vicinity of the user for which the intention data indicative of an intention to perform an elevator boarding.
